(19) United States
(12) Patent Application Publication
(10) Pub. No.: US 2007/0057924 A1
(43) Pub. Date: Mar. 15, 2007

(54) Input Device for a Vehicle

(76) Inventors: Michael Prados, San Francisco, CA (US); Jackie Lai, Mountain View, CA (US); Brian Lathrop, San Jose, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/459,826

(22) Filed: Jul. 25, 2006

Related U.S. Application Data
(60) Provisional application No. 60/716,747, filed on Sep. 13, 2005.

(51) Int. Cl. G09G 5/00

(52) U.S. Cl. 345/173

(57) ABSTRACT

An input device, especially for a vehicle, includes a display for optical display of information, a touchscreen arranged above the display to input commands by touching an operating surface of the touchscreen, an actuator to move the touchscreen in at least one direction, essentially parallel to the operating surface, and a control to drive the actuator, so that the touchscreen is moved in a first time interval with a first movement function and in a second time interval connected to the first time interval with a second movement function different from the first movement function.

### BACKGROUND OF THE INVENTION

The invention concerns an input device, especially for a vehicle, with a touchscreen.

A touchscreen is known, for example, from DE 201 02 197 U1 (incorporated by reference). A touchscreen for display of electronic signals and a confirming touch input of characters and symbols, consisting of a functional level for display and key input and a higher order, point-deformable protective level corresponding to it, is disclosed in DE 201 02 197 U1. A confirmation signal for the sense of touch (haptic stimulation) of the user, detectable at the position of the contact point in the deformed protective level, is generated during selection of certain points of the functional level by touching the protective level, and the confirmation signal for the sense of touch (haptic stimulation) is generated by oscillation elements eccentrically arranged within and/or beneath the functional level. In addition, transmission of the generated oscillations from the functional level to the protective level occurs in the touchscreen known from DE 201 02 197 U1 by direct contact of the two levels and/or via the edge regions of these levels by rigid or elastic connection elements.

Touchscreens are also known from U.S. Pat. No. 4,885,565 and EP 920 704 B1. Appropriate touchscreens can be obtained, for example, from 3M™ (see www.3M.com). Additional details concerning touchscreens can be taken from EP 1 560 102 A1.

A touch control with haptic feedback for input of signals into a computer and for output of forces to a user of the touch control is known from DE 201 80 024 U1 and the corresponding WO 01/54109A1 (incorporated by reference) for haptic feedback, in which the touch control has a touch input device that has a roughly flat contact surface, operated so that a position signal is entered into a processor of the computer based on a position on the contact surface that a user touches, in which the position signal indicates the position in two dimensions. The touch control according to WO 01/54109 A1 also has at least one actuator connected to the touch input device, in which the actuator sends a force to the touch input device, in order to provide a haptic sensation to the user touching the contact surface, in which the actuator sends the force directly to the touch input device based on force information sent by the processor.

Haptic feedback is also known from U.S. Pat. No. 6,429,846, WO 03/038800 A1 (incorporated by reference), U.S. Pat. No. 5,988,902, WO 922/26230 A1 (incorporated by reference), WO 97/21160 A1 (incorporated by reference), DE 200 22 244 U1 (incorporated by reference) and WO 03/41046 A1 (incorporated by reference).

U.S. Pat. No. 6,118,435 discloses a touch panel.

An operating element for a device with several selectable menus, functions and/or function values is known from DE 197 31 285 A1, which has a surface that can be grasped by the user, and via which selection can be carried out by local movement or touching of the surface. The surface is variable in its configuration corresponding to the selected and/or selectable menu, function and/or function menu.

The task of the invention is to improve an input device with a touchscreen. It is desirable to create an input device particularly suited for vehicles.

### SUMMARY OF THE INVENTION

The aforementioned task is solved by an input device, especially for a vehicle, in which the input device includes a display for optical display of information, a touchscreen arranged above the display to input commands by touching an operating surface of the touchscreen, an actuator for movement of the touchscreen in at least one direction at least essentially parallel to the operating surface and a control to drive the actuator, so that the touchscreen is moved in a first time interval with a first movement function and with a second time interval connected to the first time interval with a second movement function different from the first movement function. The aforementioned task is also solved by a method of operating of such an input device.

The touchscreen according to the invention is especially a transparent touchscreen. The display according to the invention is especially a display or matrix display for variable display of information. A first display according to the invention can be a TFT, for example.

A means of display of optically displayed information according to the invention can be display of an operating element.

In one embodiment of the invention, the first movement function has a fraction corresponding to a step response of an at least second-order delay element.

In another embodiment of the invention, the second movement function has a fraction corresponding to a step response of a delay element of at least the second order and a periodic fraction, especially a decreasing one.

In another embodiment of the invention, the fraction corresponding to a step response of a delay element of at least the second order and the periodic fraction are linked by addition.

In another embodiment of the invention, the actuator can be driven by means of the control so that or it is prescribed that the touchscreen, in the third time interval connected to the second time interval, is moved with a third movement function different from the first and second movement function.

In another embodiment of the invention, the third movement function has a decreasing periodic fraction.

In another embodiment of the invention, the periodic fraction has a frequency between 30 Hz and 70 Hz.

In another embodiment of the invention, the third movement function has a linearly diminishing fraction linked to the decreasing periodic fraction by addition.

In another embodiment of the invention, the maximum of the movement is at least 0.1 mm and, at most, 1 mm, especially, at most, 0.5 mm. The movement has died out according to another embodiment of the invention after 100 ms, especially after 50 ms.

In another embodiment of the invention, the actuator is controllable by means of the control so that or it is prescribed that the touchscreen is moved around a rest position of a touchscreen, so that the integral of the movement of the touchscreen in a first direction is at least 2.5 times, especially 4 times the integral of the movement of the touchscreen in a second direction opposite the first direction.

The rest position of the touchscreen according to the invention is the (rest) position of the touchscreen before movement of the touchscreen or the (rest) position of the touchscreen after movement of the touchscreen. Generally, the (rest) position of the touchscreen before movement of the touchscreen should be the same as the (rest) position of the touchscreen after movement of the touchscreen.

An integral of the movement of the touchscreen according to the invention should then, in particular, be the integral of the movement of the touchscreen from the beginning of the movement to the time, at which the movement of the touchscreen has essentially died out, or at which the movement of the touchscreen is no longer palpable for an (average) operator. It is advantageously prescribed that only the integral of the movement of the touchscreen for a time interval about 50 ms to 100 ms long is the aforementioned integral of the movement of the touchscreen according to the invention.

In another embodiment of the invention, the actuator is controllable by means of the control so that or it is prescribed that the touchscreen is initially moved essentially in the second direction and then in the first direction.

In another embodiment of the invention, the movement in the first direction is at least twice the movement in the second direction.

In another embodiment of the invention, the actuator is controllable by means of the control so that or it is prescribed that the touchscreen is moved around a rest position, initially essentially in a first direction and then in a second direction opposite the first direction, in which the movement in the first direction is, at most, 0.5 times the movement in the second direction.

In another embodiment of the invention, it is prescribed that the touchscreen, depending on the position of touching of the touch surface, is moved differently by means of the information displayed by the display and/or the type of touching of the touch surface.

The aforementioned task is also solved by an input device, especially for a vehicle, in which the input device includes a display for optical display of information, a touchscreen arranged above the display for input of commands by touching an operating surface of the touchscreen, an actuator to move the touchscreen in at least one direction essentially parallel to the operating surface and a control to drive the actuator, so that the touchscreen is moved with a periodic fraction with a frequency between 10 Hz and 80 Hz, especially between 30 Hz and 70 Hz. The aforementioned task is also solved by a method for operation of such an input device.

In another embodiment of the invention, the actuator is controllable by means of the control so that or it is prescribed that the touchscreen is moved with a periodic fraction with a frequency between 40 Hz and 60 Hz.

In another embodiment of the invention, the maximum movement is at least 0.1 mm and, at most, 1 mm, especially, at most, 0.5 mm. The movement essentially dies out in another embodiment of the invention after 200 ms.

In another embodiment of the invention, it is prescribed that the touchscreen, depending on the position of touching of the touch surface, is moved differently by means of information displayed by the display and/or the type of touching of the touch surface.

The aforementioned task is also solved by an input device, especially for a vehicle, in which the input device includes a display for optical display of information, a touchscreen arranged above the display to input commands by touching an operating surface of the touchscreen, an actuator to move the touchscreen in at least one direction, essentially parallel to the operating surface, and a control to drive the actuator, so that the touchscreen is moved around a rest position of the touchscreen, so that the integral of the movement of the touchscreen in a first direction is at least 2.5 times the integral of the movement of the touchscreen in a second direction opposite the first direction. The aforementioned task is also solved by a method for operation of such an input device.

In one embodiment of the invention, the actuator is controllable by means of the control so that or it is prescribed that the touchscreen is moved around a rest position of the touchscreen, so that the integral of the movement of the touchscreen in the first direction is at least 4 times, especially at least 5 times the integral of the movement of the touchscreen in a second direction opposite the first direction.

In another embodiment of the invention, the actuator is controllable by means of the control so that or its prescribed that the touchscreen is initially moved essentially in the second direction and then in the first direction.

In another embodiment of the invention, the movement in the first direction is at least 2 times the movement in the second direction.

In another embodiment of the invention, the maximum movement is at least 0.1 mm and, at most, 1 mm, especially, at most, 0.5 mm. The movement in another embodiment of the invention has essentially died out after 100 ms, especially after 50 ms.

In another embodiment of the invention, the touchscreen is moved with a periodic fraction with a frequency between 10 Hz and 80 Hz, especially between 30 Hz and 70 Hz, especially between 40 Hz and 60 Hz.

In another embodiment of the invention, it is prescribed that the touchscreen is moved differently, depending on the position of touching of the touch surface of the information displayed by the display and/or the type of touching of the touchscreen.

The aforementioned task is also solved by an input device, especially for a vehicle, in which the input device includes a display for optical display of information, a touchscreen arranged above the display for input of commands by touching an operating surface of the touchscreen, an actuator to move the touchscreen in at least one direction, essentially parallel to the operating surface, and a control to drive the actuator, so that the touchscreen is moved around a rest position of the touchscreen in a first direction by at least 50 μm and then in a second direction opposite the first direction, in which the movement in the second direction is at least twice the movement in the first direction. The aforementioned task is also solved by a method for operation of such an input device.

In another embodiment of the invention, the maximum movement is at least 0.1 mm and, at most 1 mm, especially, at most, 0.5 mm. In another embodiment of the invention, the movement has essentially died out after 100 ms, especially after 50 ms.

In another embodiment of the invention, it is prescribed that the touchscreen is moved differently, depending on the position of touching of the touch surface of the information displayed by the display and/or the type of touching of the touch surface.

The aforementioned task is also solved by an input device, especially for a vehicle, in which the input device includes a display for optical display of information, a touchscreen arranged above the display for input of commands by touching an operating surface of the touchscreen, an actuator to move the touchscreen in at least one direction, essentially parallel to the operating surface, and a control to generate a haptic feedback by driving the actuator, so that the touchscreen is moved alternately according to a first movement mode or at least a second movement mode different from the first movement mode, in which the touchscreen according to the first movement mode is moved with a periodic fraction with a frequency between 10 Hz and 80 Hz, especially between 30 Hz and 70 Hz, and/or by a rest position of the touchscreen, so that the integral of the movement of the touchscreen in a first direction is at least 2.5 times the integral of the movement of the touchscreen in a second direction opposite the first direction. The aforementioned task is also solved by a method for operation of such an input device.

In another embodiment of the invention, the choice between the first movement mode and the second movement mode is dependent on the type of information displayed by the display, the position of touching of the touch surface, the information displayed by the display and/or the type of touching of the touch surface.

Vehicle according to the invention is especially an individual land vehicle, usable in traffic. Vehicles according to the invention are not particularly restricted to land vehicles with internal combustion engines.

Touching of the touchscreen according to the invention can be only pressing on the touchscreen.

A periodic movement according to the invention, in particular, include a movement at least for a period with an amplitude of 20 μm.

Additional advantages and details are apparent from the following description of practical examples.

### BRIEF DESCRIPTION OF THE DRAWINGS

FIG. 1 shows a practical example for a cockpit of a vehicle;

FIG. 2 shows a practical example of an input device with a connect to control in a sketch;

FIG. 3 shows the input device according to FIG. 2 in a perspective top view;

FIG. 4 shows the input device according to FIG. 2 in a cross-section;

FIG. 5 shows the input device according to FIG. 2 from below;

FIG. 6 shows a modified embodiment of the input device according to FIG. 2 in a cross-section;

FIG. 7 shows another modified embodiment of the input device according to FIG. 2 in a cross-section;

FIG. 8 shows the input device according to FIG. 5 in a perspective view from below;

FIG. 9 shows another modified embodiment of the input device according to FIG. 2 in an exploded view;

FIG. 10 shows another practical example of an input device in a perspective top view;

FIG. 11 shows a practical example of a folded or telescoping region;

FIG. 12 shows another practical example of a folded or telescoping region;

FIG. 13 shows another practical example of a folded or telescoping region;

FIG. 14 shows another practical example of an input device in a perspective top view;

FIG. 15 shows a practical example of movement on a touchscreen;

FIG. 16 shows another practical example of movement on a touchscreen;

FIG. 17 shows another practical example of movement on a touchscreen, according to FIG. 16, under the influence of touching by a human finger;

FIG. 18 shows another practical example of movement on a touchscreen;

FIG. 19 shows another practical example of movement on a touchscreen, according to FIG. 18, under the influence of touching by a human finger;

FIG. 20 shows another practical example of movement on a touchscreen; and

FIG. 21 shows another practical example of movement on a touchscreen, according to FIG. 20, under the influence of touching by a human finger.

### DETAIL DESCRIPTION OF PREFERRED PRACTICAL EXAMPLES

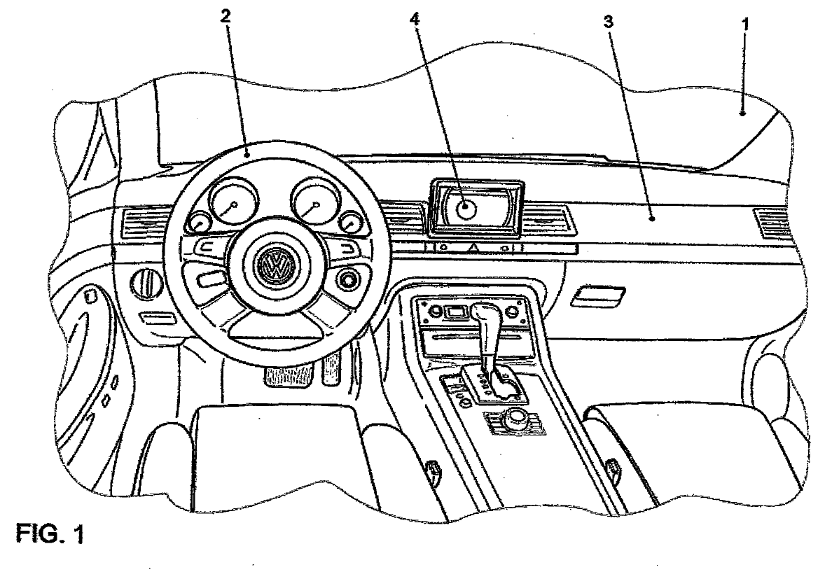

FIG. 1 shows a practical example for a cockpit of a vehicle 1. In cockpit 1, a steering wheel 2 is arranged beneath the dashboard 3. The dashboard 3 has an input device 4 arranged next to steering wheel 2. As an alternative or in addition, an input device corresponding to input device 4 can also be arranged in steering wheel 2.

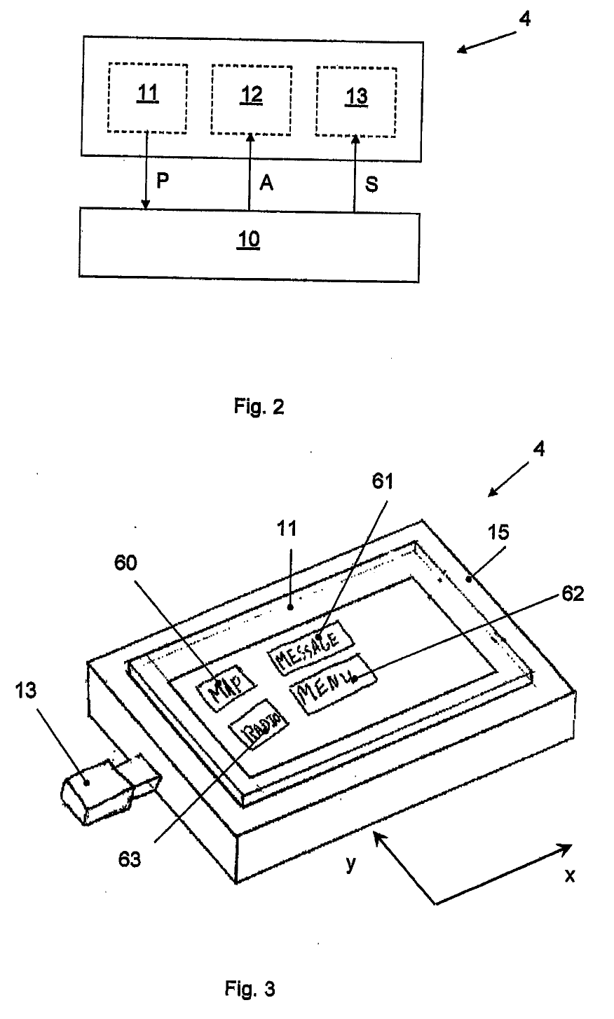

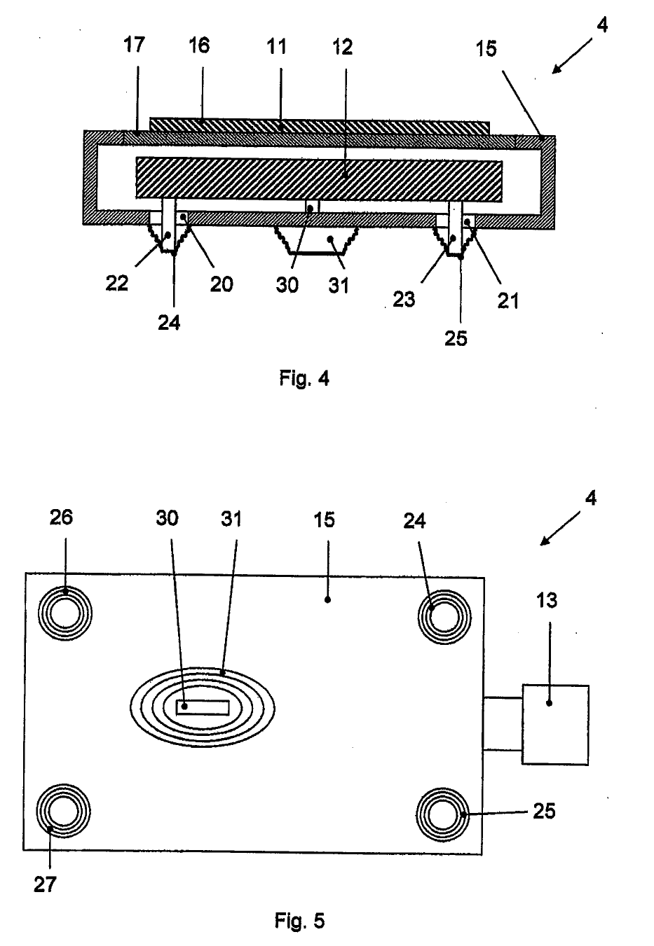

FIG. 2 shows the input device 4 with a connected control in a sketch. FIG. 3 shows the input device 4 in a perspective top view. FIG. 4 shows the input device 4 in a cross-section. FIG. 5 shows the input device 4 from below. The input device 4 includes a housing 15, a display 12 arranged in the housing 15 for optical display of information, for example, the operating elements designated in FIG. 3 with reference numbers 60, 61, 62 and 63, a touchscreen 11 arranged above display 12 and connected to the housing for input of commands by touching an operating surface 16 of touchscreen 11, and an actuator 13 to move the housing 15 and therefore touchscreen 11 relative to display 12 in the x-direction, in which x and y denote the coordinates of an orthogonal coordinate system of a plane parallel to the operating surface 16 of touchscreen 11. The input device 4 includes a device 12, by means of which different information can be displayed on display 12 by means of a corresponding display signal A by output. In addition, the control 10 enters a position signal P sent by the touchscreen 11, which states the position of touching of the operating surface 16 or pressing on the operating surface 16. In addition, the control 10, by output of an actuator control signal S, controls movement of actuator 13. An embodiment of the actuator 13 can be derived from EP 1 560 102 A1. In addition, piezo actuators or so-called voice coils can be used as actuator 13.

The touchscreen 11 is also fastened to housing 15. Housing 15 is then transparent, at least in the region beneath touchscreen 11, designated with reference number 17. As an alternative, the touchscreen 11 can also be configured as part of housing 15.

The housing 15, as shown in FIG. 4 and FIG. 5, includes four openings 20 and 21, each covered by a flexible sleeve 24, 25, 26 and 27, through which fastening elements 22 and 23 are guided to fasten display 12 to steering wheel 2 or dashboard 3. The housing 15 also includes an additional opening covered by an additional flexible sleeve 31, through which a plug-in contact 30 for poser supply of display 12 and to transmit the display signal A to display 12 is guided. The flexible sleeves 24, 25, 26, 27 and 31 can consist of an elastomer or include an elastomer. In particular, it is prescribed that the flexibility of sleeves 24, 25, 26, 27 and 31 is adjusted to the weight of housing 15, including touchscreen 11, so that the housing 15 (including touchscreen 11), in conjunction with sleeves 24, 25, 26, 27 and 31, has a mechanical natural frequency between 5 Hz and 150 Hz, especially 30 Hz and 70 Hz. The natural frequency is then adjusted to actuator 13 or the natural frequency chosen according to actuator 13.

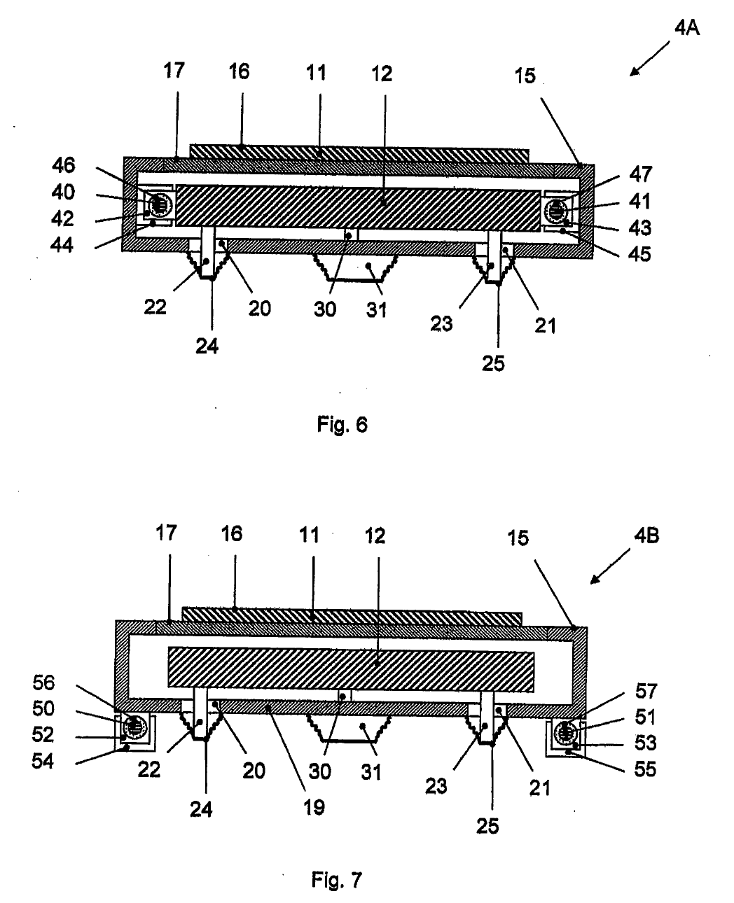

FIG. 6 shows an input device 4A, modified relative to input device 4, in a cross-section, in which the same reference numbers denote the same or equivalent elements as in FIG. 2, FIG. 3, FIG. 4 and FIG. 5. The input device 4A includes connection elements for shape-mated connection of housing 15 to display 12, so that the housing 15 can only be moved along a straight line relative to display 12. For this purpose, a connection element includes at least one fastening element 44 or 45 connected to the housing 15 for fastening of a rod 40 or 41. In addition, a connection element includes at least one sliding element 42 or 43 connected to the display 12 with at least one sliding bearing 46 or 47, by means of which the sliding element 42 or 43 can be moved along rod 40 or 41. It can also be prescribed that the sliding element 42 or 43 is (firmly) connected to housing 15 and the fastening element 44 or 45 to display 12.

FIG. 7 shows another input device 4B, modified relative to input device 4, in a cross-section, in which the same reference numbers denote the same or equivalent elements as in FIG. 2, FIG. 3, FIG. 4 and FIG. 5. The input device 4B includes connection elements for shape-mated connection of housing 15 to display 12, so that the housing 15 can only be moved along a straight line relative to display 12. For this purpose, a connection element includes at least one fastening element 54 or 55, connected or connectable to steering wheel 2 or dashboard 3, for fastening of rod 50 or 51. In addition, a connection element includes at least one sliding element 52 or 53, connected to the housing 15 or a lower part 19 of housing 15, with a sliding bearing 56 or 57, by means of which the sliding element 52 or 53 can be moved along 50 or 51. It can also be prescribed that the sliding element 52 or 53 is (firmly) connectable or connected to the steering wheel 2 or dashboard 3 and the fastening element 54 or 55 to the housing 15. The movement connection between display 12 and housing 15 can then occur via the steering wheel 2 or dashboard 3 or via an additional element. For example, both the sliding elements 52 and 53 and the fastening elements 54 and 55 can be fastened to a frame. This frame can again be connected to steering wheel 2 or dashboard 3 for incorporation in vehicle 1.

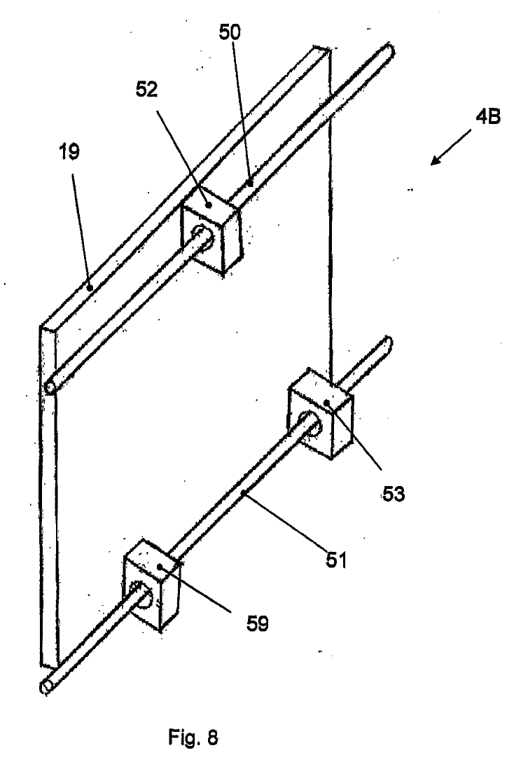

FIG. 8 shows (simplified) a cutout of the input device 4B in a perspective view from below. Reference number 59 denotes a sliding element corresponding to sliding elements 52 and 53. Advantageously, no more than three sliding elements are provided. The sleeves 24, 25, 26, 27 and 31 are not shown, for reasons of clarity, in FIG. 8.

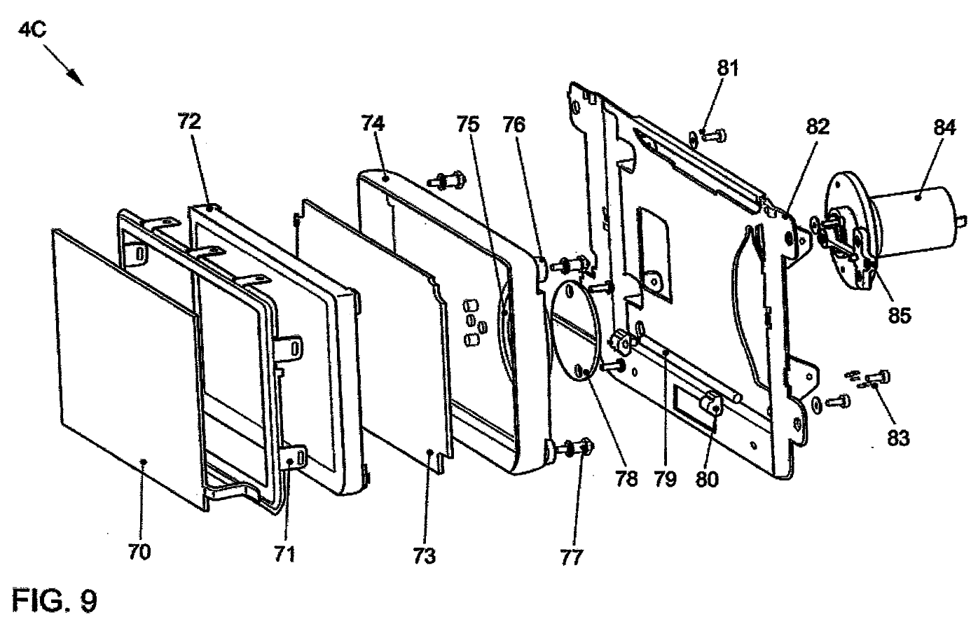

FIG. 9 shows another input device 4C, modified relative to input device 4, in an exploded view (not complete for reasons of clarity). The input device 4C includes a touchscreen 70 corresponding to touchscreen 11 and a mount 71 for touchscreen 70. The input device 4C also includes a display 72 corresponding to display 12, as well as a control circuit board 73 connected to display 72. The input device 4C also includes a support 74 with a control circuit board 75 connected to touchscreen 70. The touchscreen 70, mount 71 and support 74 form a housing corresponding to housing 15.

The support 74 includes flexible sleeves or seals 78, through which pins 77 for fastening of display 72 to a frame 82 are pushed, in which the pins 77 are fastened to the frame 82 with screws 81. The input device 4C also includes an interface circuit board 78 for data connection of input device 4C to control 10 or a control corresponding to control 10. The input device 4C also includes a fastening element 80 that can be fastened to frame 82 by means of a screw 83 for fastening of a rod 79. The support 74 includes on its back (not apparent in FIG. 9) connection elements for shape-mated connection of support 74 to frame 82, so that the support 74 can be moved along rod 79 relative to frame 82. In this embodiment, the housing and display 72 are also connected to each other in shape-mated according to the invention, so that the housing could only be moved along a straight line relative to display 72.

The input device 4C also includes an actuator 84 corresponding to actuator 13, which includes an eccentric 85, which can correspond to the eccentric of the actuators shown in EP 1 560 102 A1.

The control 10 is not shown in FIG. 3 to FIG. 9, for reasons of clarity.

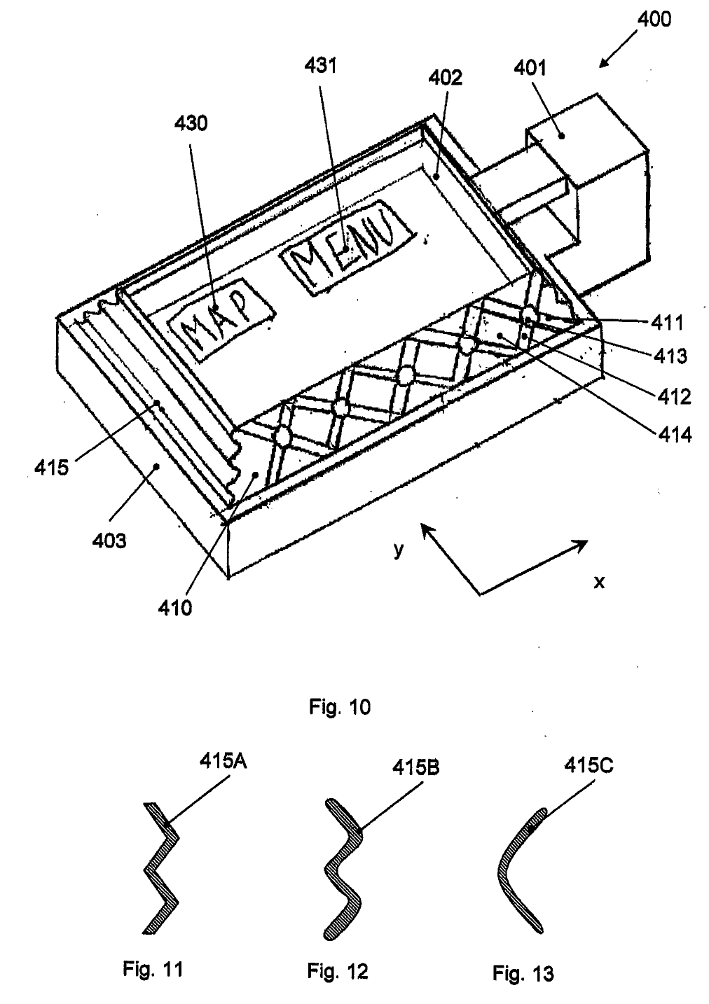

FIG. 10 shows a practical example of an input device 400 for use, instead of input device 4 in vehicle 1, in a perspective top view. The input device 400 includes a display 403, optionally arranged in a housing, for optical display of information, like the operating elements designed with reference numbers 430 and 431 in FIG. 10, a touchscreen 402 arranged above display 403 and connected to display 403 (or its housing) for input of commands by touching an operating surface of the touchscreen 402 and an actuator 401 to move the touchscreen 402 relative to display 403. A gap is provided between touchscreen 402 and display 403, so that the touchscreen 402 can be moved relative to display 403 without mechanical surface wear. The input device 400 includes control (not shown) corresponding to control 10. The touchscreen 402 can include a transparent support, including a touchscreen in the narrow sense, which is arranged on the support.

A flexible element 410 to prevent penetration of dust particles (into the gap) between display 403 and touchscreen 402 is arranged between display 403 and touchscreen 402. For this purpose, the flexible element 410 is arranged continuous on the edge of touchscreen 402. The flexible element 410 has a rigidity adjusted to a weight of the touchscreen 402, so that the touchscreen 402, in conjunction with the flexible element 410, has a mechanical natural frequency between 5 Hz and 150 Hz, especially 30 Hz and 70 Hz, in the movement direction (i.e., in the present practical example, in the x-direction).

The flexible element 410 consists essentially of an elastomer and includes—at least in the movement direction (i.e., in the present practical example, in the x-direction)—essentially linearly extended grooves 411 and 412 that intersect in pairs, so that a common intersection site 413, configured as an arched dome, is present between two grooves 411 and 412. The grooves 411 and 412 are sloped at roughly 45° relative to the operating surface of the touchscreen 402. The transition between a groove 411 or 412 and a flat region 414 has a radius of curvature that is three to five times the thickness of a material, from which the groove 411 or 412 is formed. Appropriate embodiments for a region of a flexible element 410 configured in this way can be derived from U.S. Pat. No. 4,044,186 (incorporated by reference), as well as the corresponding DE 2 349 499 (incorporated by reference).

The flexible element 410 includes a folded or telescoping region 415, perpendicular to the movement direction (i.e., in the present practical example, perpendicular to the x-direction or in the y-direction). Additional practical examples of the folded or telescoping region 415A, 415B and 415C are shown in FIG. 11, 12 and 13.

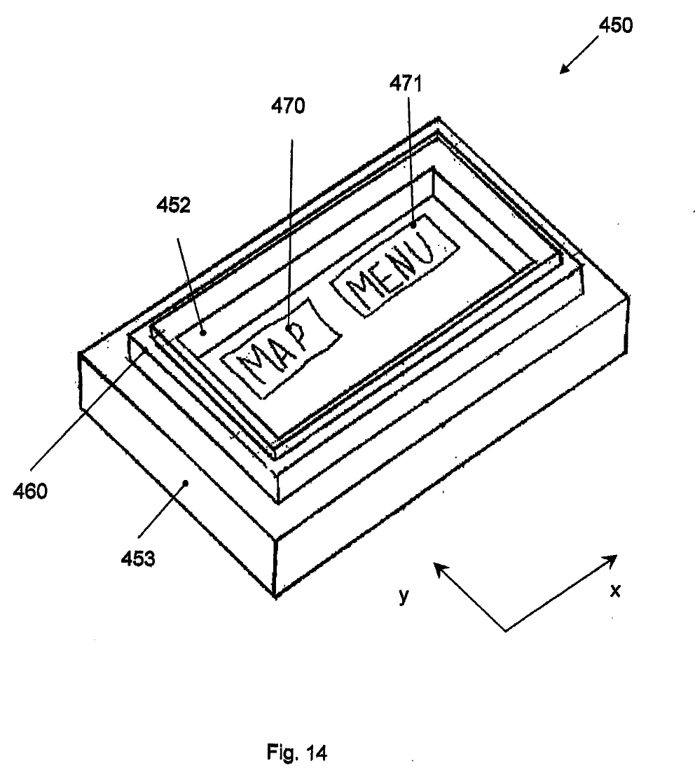

FIG. 14 shows another practical example of an input device 450 for use, instead of input device 4, in a perspective top view. The input device 450 includes a display 453, optionally arranged in the housing, for optical display of information, like the operating elements designed with reference numbers 470 and 471 in FIG. 14, a touchscreen arranged above display 453 and connected to display 453 (or its housing) for input of commands by touching an operating surface of the touchscreen, and an actuator corresponding to actuator 451, but not shown in FIG. 14, for movement of the touchscreen 452 relative to display 453. Between touchscreen 452 and display 453, a gap is provided, so that the touchscreen 452 can be moved relative to display 453 without mechanical surface wear. The input device 450 includes a control (not shown) corresponding to control 10. The touchscreen 452 can be a transparent support, including a touchscreen in the narrow sense, which is arranged on the support.

Between the display 453 and touchscreen 452, a flexible foamed element 460 to prevent penetration of dust particles between display 453 and display 452 is arranged. For this purpose, the flexible foamed element 460 is arranged continuous on the edge of touchscreen 452. The flexible foamed element 460 has a rigidity adjusted to a weight of the touchscreen 452, so that the touchscreen 452, in conjunction with the flexible foamed element 460 in the movement direction (in the present practical example, in the x-direction), has a mechanical natural frequency between 5 Hz and 150 Hz, especially 30 Hz and 70 Hz. The flexible foamed element 460 consists essentially of polyurethane.

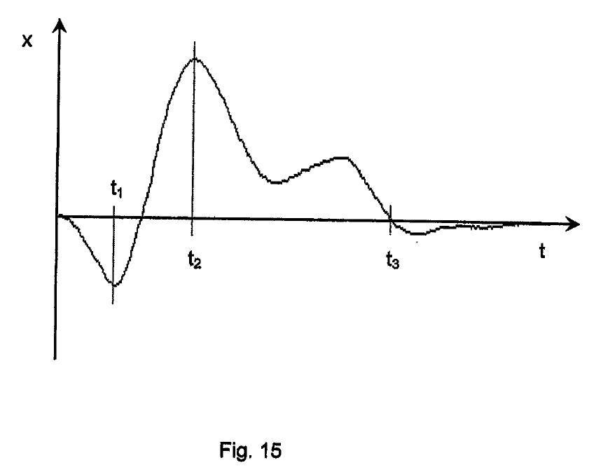

If the touchscreen 402 (or its operating surface) is touched by a user, for example, in the region of the operating element, depicted by means of display 403, or the touchscreen 452 (or its operating surface) is touched by a user in the region of the operating element 470, depicted by means of display 453, or the operating surface 16 of touchscreen 11 is touched by a user, for example, in the region of the operating element 60, depicted by means of display 12, a map is displayed by means of display 403, 453 or 12. In addition, the control generates a control signal S for haptic confirmation of successful operation of operating element 430, 470 or 60. The actuator 401, 451 or 13 is then driven by means of control signal S, so that it moves the touchscreen 402 or 452 or the housing 15 and therefore touchscreen 11 (with negligible feedback by the user) relative to display 403, 453 or 12 in the x-direction, as shown in FIG. 15, according to the function

$$x = \{ \begin{matrix}{a}_{1} ( 1 - β ) ( {ⅇ}^{{c}_{1} {t}^{{d}_{1}}} - 1 ) & ∀ 0 \leq t < {t}_{1} \\ {a}_{2} ( 1 - β ) ( 1 - {ⅇ}^{{{c}_{2} ( t - {t}_{1} )}^{{d}_{2}}} ) + {a}_{4} ( \begin{matrix}sin ( {ω}_{ 1} ( t - {t}_{ 1} ) + {Φ}_{ 1} ) - \\ sin ( {ω}_{ 1} \cdot {t}_{ 1} + {Φ}_{ 1} )\end{matrix} ) {ⅇ}^{{c}_{5} {( t - {t}_{1} )}^{{d}_{5}}} & ∀ {t}_{1} \leq t < {t}_{2} \\ ( {a}_{2} - {a}_{1} ) ( 1 - \frac{t - {t}_{2}}{{t}_{3} - {t}_{2}} ) + {a}_{4} ( \begin{matrix}sin ( {ω}_{1} ( t - {t}_{1} ) + {Φ}_{1} ) - \\ sin ( {ω}_{1} \cdot {t}_{1} + {Φ}_{1} )\end{matrix} ) {ⅇ}^{{{c}_{5} ( t - {t}_{1} )}^{{d}_{3}}} & ∀ {t}_{2} \leq t < {t}_{3}\end{matrix}$$

in which t is time, and in which:

$${c}_{1} = \frac{ln β}{{t}_{1}^{{d}_{1}}}$$

$$and$$

$${c}_{2} = \frac{ln β}{{t}_{1}^{{d}_{2}}}$$

$$and$$

$${c}_{5} = \frac{ln β}{{( {t}_{3} - {t}_{1} )}^{{d}_{5}}}$$

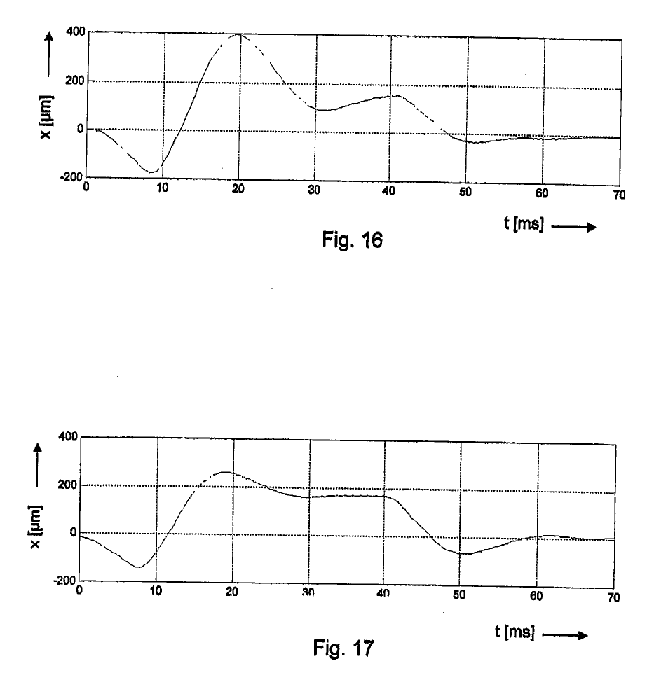

For the present practical example, the value of the variables according to Table 1 are chosen, so that the touchscreen 402 or 452 or housing 15 and therefore touchscreen 11 (with negligible feedback by the user) is moved in the x-direction, as shown in FIG. 16, relative to display 403, 453 or 12. FIG. 15 shows, as an example, the actual movement of touchscreen 402, touchscreen 452 or housing 15 and therefore touchscreen 11 relative to display 403, 453 or 12 in the x-direction, for example, by feedback of a finger of the user.

TABLE 1

| Variables | Value | |
|---|---|---|
| t₁ | 10 | ms |
| t₂ | 25 | ms |
| t₃ | 50 | ms |
| a₁ | 200 | μm |
| a₂ | 450 | μm |
| a₄ | 75 μm ± 50% | |
| d₁ | 2 | |
| d₂ | 2 | |
| d₅ | 5 | |
| β | 5 | μm |

| | |
|---|---|
| ω₁ | π · 100 Hz |
| Φ₁ | −π/2 |

The haptic confirmation, described with reference to FIG. 16 and FIG. 17, can also be used for haptic confirmation according to EP 1 560 102 A1 (incorporated by reference) and/or U.S. Patent Application 60/640360 (incorporated by reference).

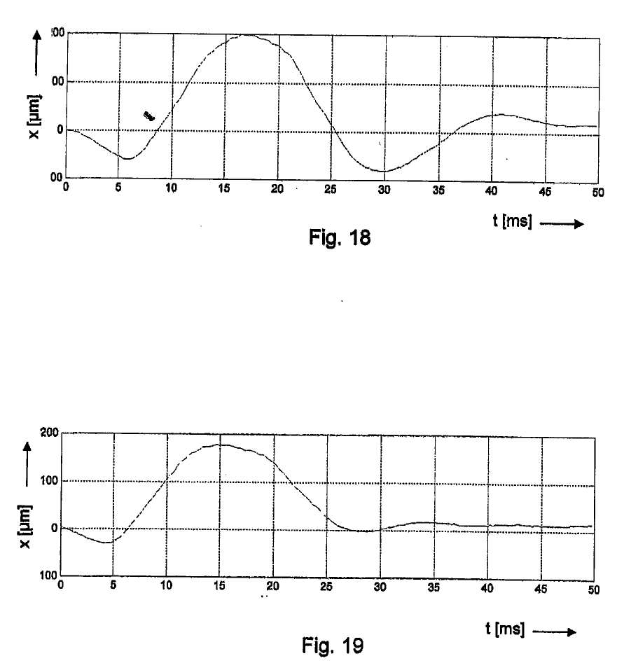

It can be prescribed that a slider is displayed by means of display 403, 453 or 12. It can be prescribed that during operating of this slider by touching touchscreen 402 (or its operating surface) or touchscreen 452 (or its operating surface) or the operating surface of touchscreen 11 by a user in the region of the slider, depicted by means of display 12, a control signal S for haptic confirmation of successful operation of the slider is generated. The actuator 401, 451 or 13 is then driven by means of control signal S, so that it moves the touchscreen 402 or 452 or housing 15 and therefore touchscreen 11 (with negligible feedback by the user) relative to display 403, 453 or 12 in the x-direction, as shown in FIG. 18, also according to the function

$$x = \{ \begin{matrix}{a}_{1} ( 1 - β ) ( {ⅇ}^{{c}_{1} {t}^{{d}_{1}}} - 1 ) & ∀ 0 \leq t < {t}_{1} \\ {a}_{2} ( 1 - β ) ( 1 - {ⅇ}^{{{c}_{2} ( t - {t}_{1} )}^{{d}_{2}}} ) + {a}_{4} ( \begin{matrix}sin ( {ω}_{ 1} ( t - {t}_{1} ) + {Φ}_{1} ) - \\ sin ( {ω}_{1} \cdot {t}_{1} + {Φ}_{1} )\end{matrix} ) {ⅇ}^{{c}_{5} {( t - {t}_{1} )}^{{d}_{5}}} & ∀ {t}_{1} \leq t < {t}_{2} \\ ( {a}_{2} - {a}_{1} ) ( 1 - \frac{t - {t}_{2}}{{t}_{3} - {t}_{2}} ) + {a}_{4} ( \begin{matrix}sin ( {ω}_{1} ( t - {t}_{1} ) + {Φ}_{1} ) - \\ sin ( {ω}_{1} \cdot {t}_{1} + {Φ}_{1} )\end{matrix} ) {ⅇ}^{{{c}_{5} ( t - {t}_{1} )}^{{d}_{5}}} & ∀ {t}_{2} \leq t < {t}_{3}\end{matrix}$$

in which the values of the variables according to Table 2 are chosen.

FIG. 19 shows, as an example, the actual movement of touchscreen 402 or touchscreen 452 or housing 15 and therefore touchscreen 11 relative to display 12 in the x-direction, which is produced by the feedback of a finger of the user.

TABLE 2

| Variables | Value | |
|---|---|---|
| t₁ | 5 | ms |
| t₂ | 25 | ms |
| t₃ | 50 | ms |
| a₁ | 60 | μm |
| a₂ | 80 | μm |
| a₄ | 100 μm ± 20% | |
| d₁ | 2 | |
| d₂ | 2 | |
| d₅ | 3 | |
| β | 5 | μm |

| | |
|---|---|
| ω₁ | π · 100 Hz |
| Φ₁ | −π/2 |

If touchscreen 402 (or its operating surface) is touched by a user, for example, in the region of the operating element 403 displayed by display 403, the touchscreen 452 (or its operating surface) is touched by the user in the region of the operating element 471, displayed by means of a display 453, or the operating surface 16 of the touchscreen 11 is touched by a user in the region of the operating element 63, displayed by means of display 12, the control generates a control signal S for haptic warning before operation of operating element 431, 471 or 63. The actuator 401, 451 or 13 is then driven by control signal S, so that it moves the touchscreen 402 or 452 or the housing 15 and therefore touchscreen 11 (with negligible feedback by the user) relative to display 403, 453 or 12 in the x-direction, as shown in FIG. 15, according to the function

$$x = \{ \begin{matrix}a \cdot sin ( ω t ) & ∀ 0 \leq 100 ms \\ ( a \cdot sin ( ω t ) ) {ⅇ}^{- {c ( t - 100 ms )}^{d}} & ∀ 100 \leq t\end{matrix}$$

in which the values of the variables are chosen according to Table 3.

TABLE 3

| Variables | Value |
|---|---|
| a | 50 μm bis 150 μm |
| c | 800 bis 1200 |
| d | 1.5 ^{to} 2.5 |
| ω | π · 100 Hz |

FIG. 21 shows, as an example, the actual movement of the touchscreen 402 or touchscreen 452 or housing 15 and therefore touchscreen 11 relative to the display 12 in the x-direction, which is produced by feedback by the finger of the user.

If the touchscreen 402 (or its operating surface) is touched by a user in the region of the operating element 431, displayed by display 403, the touchscreen 452 (or its operating surface) is touched by a user in the region of the operating element 471, displayed by means of display 453, or the operating surface 16 of touchscreen 11 is touched by a user, again in the region of the operating element 63, displayed by display 12, a higher order menu is displayed by displays 403, 453 or 12. In addition, the control 10 generates a control signal S, corresponding to the already described haptic confirmation of successful operation of operating element 430, 470 or 60.

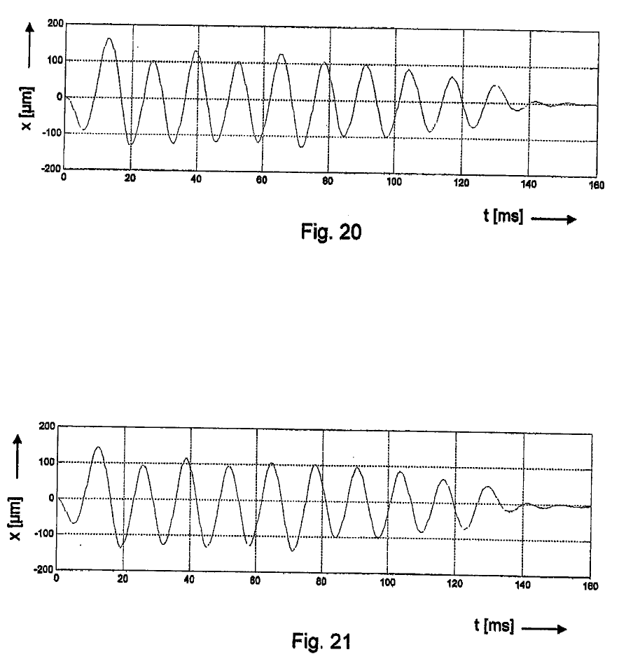

The warning, described with reference to FIG. 20 and FIG. 21, can also be used for warning according to U.S. Patent Application 60/640411.

The elements and spacings in FIGS. 2 to 15 are not necessarily drawn true to scale, considering simplicity and clarity. For example, the orders of magnitude of some elements and spacings in FIGS. 2 to 15 are exaggerated relative to other elements and spacings in FIGS. 2 to 15, in order to assure understanding of the practical examples of the present invention.

1. An input device comprising:
a display for optical display of information;
a touchscreen arranged above the display for input of commands by touching an operating surface of the touchscreen;
an actuator to move the touchscreen in at least one direction, essentially parallel to the operating surface; and
a control to drive the actuator, so that the touchscreen, in a first time interval, is moved with a first movement function and, in a second time interval following the first time interval, is moved with a second movement function, different from the first movement function.

2. An input device according to claim 1, wherein the first movement function has a fraction corresponding to a step response of an at least second-order delay element.

3. An input device according to claim 1, wherein the second movement function has a fraction and a periodic fraction corresponding to a step response of an at least second-order delay element.

4. An input device according to claim 3, wherein the periodic fraction has a frequency between 30 Hz and 70 Hz.

5. An input device according to claim 3, wherein the fraction corresponding to a step response of an at least second-order delay order and the periodic fraction are linked by addition.

6. An input device according to claim 1, wherein the second movement function has a fraction corresponding to a step response of an at least second-order delay element and a decreasing periodic fraction.

7. An input device according to claim 1, wherein the actuator can be driven by means of the control, so that the touchscreen is moved in a third time interval connected to the second time interval with a movement function different from the first and second movement functions.

8. An input device according to claim 7, wherein the third movement function has a decreasing periodic fraction.

9. An input device according to claim 8, wherein the periodic fraction has a frequency between 30 Hz and 70 Hz.

10. An input device according to claim 8, wherein the third movement function has a linearly diminishing fraction linked to the decreasing periodic fraction by addition.

11. An input device according to claim 7, wherein the third movement function has a linearly diminishing fraction.

12. An input device according to claim 1, wherein the maximum movement is at least 0.1 mm.

13. An input device according to claim 1, wherein the maximum movement is, at most, 1 mm.

14. An input device according to claim 1, wherein the maximum movement is, at most, 0.5 mm.

15. An input device according to claim 1, wherein the movement has essentially died out after 100 ms.

16. An input device according to claim 1, wherein the movement has essentially died out after 50 ms.

17. An input device according to claim 1, wherein the actuator is controllable by means of the control, so that the touchscreen is moved around the rest position of the touchscreen, so that the integral of the movement of the touchscreen in a first direction is at least 2.5 times the integral of the movement of the movement of the touchscreen in a second direction opposite the first direction.

18. An input device according to claim 17, wherein the actuator is controllable by a control, so that the touchscreen is moved around a rest position of the touchscreen, so that the integral of the movement of the touchscreen in a first direction is at least 4 times the integral of the movement of the touchscreen in a second direction opposite the first direction.

19. An input device according to claim 17, wherein the actuator can be driven by the control, so that the touchscreen is initially moved essentially in the second direction and then in the first direction.

20. An input device according to claim 18, wherein the movement in the first direction is at least 2 times the movement of the second direction.

21. An input device according to claim 20, wherein the actuator can be driven by the control, so that the touchscreen is initially moved around a rest position essentially in a first direction and then in second direction opposite the first direction, in which the movement in the first direction is, at most, 0.5 times the movement in the second direction.

22. An input device, device, particularly for a vehicle, the input device comprising:
a display for optical display of information;
a touchscreen arranged above the display for input of commands by touching an operating surface of the touchscreen;
an actuator to move the touchscreen in at least one direction, essentially parallel to the operating surface; and
a control to drive the actuator, so that the touchscreen is moved with a periodic fraction with a frequency between 30 Hz and 70 Hz.

23. An input device according to claim 22, wherein the actuator can be driven by the control, so that the touchscreen is moved with a periodic fraction with a frequency between 40 Hz and 60 Hz.

24. An input device according to claim 22, wherein the maximum movement is at last 0.1 mm.

25. An input device according to claim 22, wherein the maximum movement is, at most, 1 mm.

26. An input device according to claim 22, wherein the movement has essentially died out after 300 ms.

27. An input device, particularly for a vehicle, the input device comprising:
a display for optical display of information;
a touchscreen arranged above the display for input of commands by touching an operating surface of the touchscreen;
an actuator to move the touchscreen in at least one direction, essentially parallel to the operating surface; and
a control to drive the actuator, so that the touchscreen is moved around a rest position of the touchscreen, so that the integral of the movement of the touchscreen in the first direction is at least 2.5 times the integral of the movement of the touchscreen in the second direction opposite the first direction.

28. An input device according to claim 27, wherein the actuator can be driven by the control, so that the touchscreen is moved around a rest position of the touchscreen, so that the integral of the movement of the touchscreen in the first direction is at least 4 times the integral of the movement of the touchscreen in the second direction opposite the first direction.

29. An input device according to claim 27, wherein the actuator can be driven by the control, so that the touchscreen is moved around a rest position of the touchscreen, so that the integral of the movement of the touchscreen in the first direction is at least 5 times the integral of the movement of the touchscreen in the second direction opposite the first direction.

30. An input device according to claim 27, wherein the actuator can be driven by the control, so that the touchscreen is initially moved essentially in the second direction and then in the first direction.

31. An input device according to claim 30, wherein the movement in the first direction is at least 2 times the movement in the second direction.

32. An input device according to claim 28, wherein the movement in the first direction is at least 2 times the movement in the second direction.

33. An input device according to claim 27, wherein the maximum movement is at least 0.1 mm.

34. An input device according to claim 27, wherein the maximum movement is, at most, 1 mm.

35. An input device according to claim 27, wherein the movement has essentially died out after 100 ms.

36. An input device according to claim 27, wherein the movement has essentially died out after 50 ms.

37. An input device according to claim 27, wherein the touchscreen is moved with a periodic fraction with a frequency between 40 Hz and 60 Hz.

38. An input device, particularly for a vehicle, the input device comprising:
a display for optical display of information;
a touchscreen arranged above the display for input of commands by touching an operating surface of the touchscreen;
an actuator to move the touchscreen in at least one direction, essentially parallel to the operating surface; and
a control to drive the actuator, so that the touchscreen is moved around a rest position of the touchscreen in a first direction by at least 50 μm and then in a second direction opposite the first direct, in which the movement in the second direction is at least 2 times the movement of the first direction.

39. An input device according to claim 38, wherein the maximum movement is at least 0.1 mm.

40. An input device according to claim 38, wherein the maximum movement is, at most, 1 mm.

41. An input device according to claim 38, wherein the movement has essentially died out after 100 ms.

42. An input device according to claim 38, wherein the movement has essentially died out after 50 ms.

43. An input device, particularly for a vehicle, the input device comprising:
a display for optical display of information;
a touchscreen arranged above the display for input of commands by touching an operating surface of the touchscreen;
an actuator to move the touchscreen in at least one direction, essentially parallel to the operating surface; and
a control to generate a haptic feedback by driving the actuator, so that the touchscreen is alternately moved according to a first movement mode or at least a second movement mode different from the first movement mode, in which the touchscreen, according to the first movement mode, is move with a periodic fraction with frequency of 30 Hz and 70 Hz, or around a rest position of the touchscreen, so that the integral of the movement of the touchscreen in a first direction is at least 2.5 times the integral of the movement of the touchscreen in a second direction opposite the first direction.

44. An input device according to claim 43, wherein the choice between the first movement mode and the second movement mode is dependent on the type of information displayed by the display, the position of touching of the touch surface or the type of touching of the touch surface.
